(19) United States
(12) Patent Application Publication
(10) Pub. No.: US 2004/0015481 A1
(43) Pub. Date: Jan. 22, 2004

(54) Patent data mining

(76) Inventor: Kenneth Zinda, Cleveland Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/440,281

(22) Filed: May 16, 2003

Related U.S. Application Data
(60) Provisional application No. 60/382,850, filed on May 23, 2002.

(51) Int. Cl. G06F 7/00

(52) U.S. Cl. 707/1

(57) ABSTRACT

A system for data mining is provided. One example system provides a database that can be queried, where the database is derived from a searchable data store. The example system also provides a query generator for producing a cross tabulated set of queries to query the database using precise, focused queries that produce results that can be cross referenced. The example system also includes a matrix generator for producing a matrix of cross tabulated data retrieved from results taken from the database, and a graphics generator for producing multi-dimensioned spreadsheet like graphic outputs that display relationships between high level patent data.

It is emphasized that this abstract is provided to comply with the rules requiring an abstract that will allow a searcher or other reader to quickly ascertain the subject matter of the application. It is submitted with the understanding that it will not be used to interpret or limit the scope or meaning of the claims.

### CROSS REFERENCE TO RELATED APPLICATION

This application claims priority to the U.S. Provisional Application No. 60/382850, filed May 23rd, 2002, titled Method and System for Patent Data Mining, which is incorporated herein by reference.

### TECHNICAL FIELD

This application relates generally to data mining, and more specifically to data mining for improved patent searching and visual analyses.

### BACKGROUND

Conventional patent searching tools employ textual, key word based search engines and typically produce lists of pattern matched patents. Systems using these search tools perform little or no analysis of the retrieved patents or relationships between the retrieved patents, simply producing a list of patents through which a reviewer manually wades. Thus, the output from conventional search tools does not facilitate direct, rapid visual interpretation of relationships between patents. People employing conventional tools, after retrieving a list of patents, will still be required to identify search areas in the retrieved patents, which is a limitation of conventional systems that leads to reviewers reading irrelevant patents. Thus, conventionally it has been difficult to stay current with technology outside a core competency. Similarly, it has been hard to assess existing and emerging trends and to perform cross domain searches.

Some non data mining systems have attempted to improve on conventional keyword searching. For example, U.S. Pat. No. 6,167,370 describes subject analysis object (SAO) semantic processing of natural language queries and documents to try to reduce the number of documents retrieved and to increase their relevance to a human reviewer.

Some attempts at visualizing the results of data mining have been made. For example, U.S. patent application Ser. No. US2002/0,082,778A1 describes some bar, line and spider graphing techniques applied to patent text analysis.

Other patents, for example U.S. Pat. No. 5,544,352, titled “Method and Apparatus For Indexing, Searching and Displaying Data”, describe proximity indexing a database to facilitate matrix based searching techniques. Proximity indexing is well known in the art. The '352 patent applies proximity indexing to legal searches and then displays the results of matrix based searches on the proximity indexed databases to facilitate understanding the precedential relationships between reported cases.

Similarly, U.S. Pat. No. 5,832,494, which is a continuation in part of the '352 patent, describes graphing techniques that provide more information about each textual object retrieved in response to a matrix based search of a proximity indexed database. Thus, while providing precedential relationship data between reported cases, the '494 patent describes providing additional information (e.g., cost data, available applications, additionally available data) about a retrieved text object.

Still other non data mining patents have approached improving patent searching by building customized databases. For example, U.S. Pat. No. 5,721,910, titled “Relational Database System Containing a Multidimensional Hierarchical Model of Interrelated Subject Categories with Recognition Capabilities” concerns building a database of parsed patent data. Specifically, “the unstructured text in technical documents is reduced to fit a multidimensional hierarchy which models a complex system of scientific or business information, such as that represented by the body of patents pertinent to a particular scientific or business discipline. This method utilizes sophisticated expert technical searches (ETS) to automatically categorize technical documents, such as patents or scientific publications. This method disaggregates a set of patents or technical documents into discrete technical categories by use of a set of pre-defined search protocols to assign each document to one or more categories. A complex set of technical and/or scientific search strategies may be produced to identify and automatically categorize documents to fit a pre-defined matrix of technical categories. The matrix of technical categories models a scientific, engineering or business area and may consist of hundreds of categories on one or more levels of abstraction.” (Col. 6 ll 57-67 and Col. 7 ll 1-6). Once the database is built, graphical displays may present counts of patents that fall into different categories. This can be referred to as “first level” or “low level” data.

Other approaches to improving real time information and analysis retrieval have included parsing irrelevant words out of a document and forming a matrix of relevant words to facilitate subsequent searching. For example, U.S. Pat. No. 5,559,940 titled “Method and System For Real-Time Information Analysis of Textual Material” concerns a real-time data retrieval system that may be continuously updated as new textual information becomes available. It processes input textual data in real-time, analyzes it, reduces or eliminates unwanted data, and enhances lexical, semantic, and/or textual features of interest.

Still other patents have attempted to facilitate visualizing the semantic structure of a document. For example, U.S. Pat. No. 5,761,685, titled “Method and System for Real-Time Information Analysis of Textual Material” concerns processing a document into a two or three dimensional matrix and then viewing the document in multiple dimensions, which can facilitate visualizing relationships between documents.

Notwithstanding these patents, conventionally, it has been difficult to capture a business problem in a query and to visualize answers to business problems. Data retrieved in response to a non-characterizing query does not simplify producing a solution to the ill-captured problem. Cross referencing and/or making correlations between patents found by conventional tools still requires significant, direct efforts by a reviewer. Simple “intersection anding” of retrieved patents based on first level data (e.g., common words) has been employed to organize lists of patents into tables of patents. But, once a cell in a table is selected, manual reading typically follows.

When employing typical search engines it has been difficult, if even possible, to identify items like the state of the art in a field, crowded areas within a technological field, and sparsely populated areas in a field. Thus, the value of the list of the patents retrieved from a conventional search is limited in direct visual analysis of business problems. For example, a list of patents retrieved from a conventional search engine does little to facilitate producing comparisons between different levels of patent activity in related areas. Therefore, decisions like determining whether to buy technology in an area, sell technology in an area, license technology, develop technology, and file applications in an area are not directly addressed by a simple list of patents. Again, line graphs and bar charts related to “intersection anding” of lists of patent are improvements over generating a simple list of patents, but further improvements are still desired.

A conventional method for retrieving data from a patent search includes producing one or more keyword queries, repetitively searching using text based search engines, reading patents to determine the relevance of the patents, and repeating the searching and reading until a sufficient number of relevant patents have been retrieved. Once a sufficient number of relevant patents have been retrieved, then a reviewer applies their experience to analyze the relevant patents and manually construct analysis results that facilitate finding the answer to the identified business problem. These methods include a high degree of reviewer involvement with ultimately irrelevant patents.

### SUMMARY

The following presents a simplified summary of methods, systems, computer readable media and so on for patent data mining and business problem solution visualization to facilitate providing a basic understanding of these items. This summary is not an extensive overview and is not intended to identify key or critical elements of the methods, systems, computer readable media, and so on or to delineate the scope of these items. This summary provides a conceptual introduction in a simplified form as a prelude to the more detailed description that is presented later.

Example systems and methods described herein employ a matrix based approach for searching a document database and producing spreadsheet like graphical responses to business problems modeled by the matrix searching. The matrix approach is coupled with analytics and spreadsheet like graphical reporting of results retrieved from sets of cross tabulated queries. Rows and columns in a matrix are developed in light of a technology landscape. A technology landscape provides a general understanding of existing and emerging opportunities and threats. A technology landscape also facilitates giving a broad, easy to understand picture of the activities that surround a market and that supply it with technology and products. Multiple methods are employed to develop comprehensive sets of search terms for the cells in a matrix associated with a technology landscape. In one example, a cell in the matrix corresponds to the intersection of two single searches. In another example, a cell corresponds to the intersection of two sets of searches. Thus, there is an exponential increase in the amount of information conveyed by a cell. This facilitates improving awareness of emerging technologies and identifying alternative product markets. Clearly, the systems and methods described herein do more than simply deliver a stack of patents to be manually reviewed.

Example systems and methods described herein relate to data mining in document databases (e.g., patent databases) to facilitate direct, rapid interpretation of visual data. This visual data facilitates understanding and solving various business problems. The example systems and methods further facilitate actions like determining the patentability of a system or method and/or performing a right to use study, for example. While the systems and methods are described primarily in the context of patents, it is to be appreciated that the systems and methods described herein could be applied to other information mining areas.

Patents are retrieved in response to related sets of queries that facilitate producing, for example, matrices of retrieved patents that simplify understanding relationships between patents. Business problems like should a company enter/leave a business/technology field, should a company license/develop/sell intellectual property in a business/technology field, what is the current and historical patent activity in different technological areas of a business, and so on, are typical problems for which businesses seek answers. Employing the example methods and systems described herein facilitates reducing the amount of manual interaction by a patent reviewer over conventional methods. Furthermore, the nature and quality of the analysis and visual output is improved.

An example method for performing patent data mining includes, identifying a business problem, producing one or more query terms that relate to different ways to describe a technology or market or that partition a technological field, automatically retrieving patents, passing retrieved patents through subsequent automated processes to expand the search terms by reverse engineering documents, producing matrices of patents that satisfy cross-referenced sets of queries (which facilitates visualizing data and simplifying analysis) and graphically displaying relationships between high level patent data using spreadsheet like displays. Thus, an example system for patent data mining includes a graphical user interface that facilitates producing sets of more sophisticated search terms and queries. Similarly, the graphical user interface facilitates displaying data in a spreadsheet like graph format that facilitates direct, rapid data interpretation.

Identifying numerical and/or textual technical specifications through a matrix can include searching a patent database for pattern matched patents and identifying the fact that data associated with a technical specification is in a patent. The presence of a technical specification can be recorded to facilitate identifying whether a technical attribute is discussed, identifying patent data related to the technical specification, and identifying relationships between identified technical specifications. This in turn facilitates rank ordering patents, which simplifies finding the most relevant patents for a solution to a business problem.

Certain illustrative example methods, systems, computer readable media and so on are described herein in connection with the following description and the annexed drawings. These examples are indicative, however, of but a few of the various ways in which the principles of the methods, systems, computer readable media and so on may be employed and thus are intended to be inclusive of equivalents. Other advantages and novel features may become apparent from the following detailed description when considered in conjunction with the drawings.

### Lexicon

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

“Computer communications”, as used herein, refers to a communication between two or more computer components and can be, for example, a network transfer, a file transfer, an applet transfer, an email, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Logic”, as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to one or more electrical or optical signals, analog or digital, one or more computer instructions, a bit or bit stream, or the like.

“Software”, as used herein, includes but is not limited to, one or more computer readable, interpretable, compilable, and/or executable instructions that cause a computer, computer component, and/or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners. It will be appreciated by one of ordinary skill in the art that the form of software may be dependent on, for example, requirements of a desired application, the environment in which it runs, and/or the desires of a designer/programmer or the like.

An “operable connection” (or a connection by which entities are “operably connected”) is one in which signals, physical communication flow, and/or logical communication flow may be sent and/or received. Usually, an operable connection includes a physical interface, an electrical interface, and/or a data interface, but it is to be noted that an operable connection may consist of differing combinations of these or other types of connections sufficient to allow operable control.

“Data store”, as used herein, refers to a physical and/or logical entity that can store data. A data store may be, for example, a database, a table, a file, a list, a queue, a heap, and so on. A data store may reside in one logical and/or physical entity and/or may be distributed between two or more logical and/or physical entities.

“Query”, as used herein refers to a semantic construction that facilitates gathering and processing information. A query might be formulated in a database query language like SQL or OQL. A query might be implemented in computer code (e.g., C#, C++, javascript) that can be employed to gather information from various data stores and/or information sources.

Some portions of the detailed descriptions that follow are presented in terms of algorithms and symbolic representations of operations on data bits within a computer memory. These algorithmic descriptions and representations are the means used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise as apparent from the following discussions, it is appreciated that throughout the description, discussions utilizing terms like processing, computing, calculating, determining, displaying or the like, refer to the action and processes of a computer system and/or computer component, or similar electronic computing device, that manipulates and transforms data represented as physical (electronic) quantities within the computer system's registers and memories into other data similarly represented as physical quantities within the computer system memories or registers or other information storage, transmission or display devices.

It will be appreciated that some or all of the processes and methods of the system involve electronic and/or software applications that may be dynamic and flexible processes so that they may be performed in sequences different than those described herein. It will also be appreciated by one of ordinary skill in the art that elements embodied as software may be implemented using various programming approaches such as machine language, procedural, object oriented, and/or artificial intelligence techniques.

The processing, analyses, and/or other functions described herein may also be implemented by functionally equivalent circuits like a digital signal processor (DSP), a software controlled microprocessor, or an ASIC. Components implemented as software are not limited to any particular programming language. Rather, the description herein provides the information one skilled in the art may use to fabricate circuits or to generate computer software and/or computer components to perform the processing of the system. It will be appreciated that some or all of the functions and/or behaviors of the present system and method may be implemented as logic as defined above.

### BRIEF DESCRIPTION OF THE DRAWINGS

FIG. 1 illustrates a portion of an example data mining method.

FIG. 2 illustrates a portion of an example data mining method.

FIG. 3 illustrates a portion of an example data mining method.

FIG. 4 illustrates a portion of an example data mining method.

FIG. 5 illustrates a portion of an example data mining method.

FIG. 6 illustrates a portion of an example data mining method.

FIG. 7 illustrates a portion of an example data mining method.

FIG. 8 illustrates an example data flow through an example data mining system and method.

FIG. 9 illustrates an example data mining system.

FIG. 10 illustrates an example data mining system.

FIG. 11 illustrates an example output matrix.

FIG. 12 illustrates an example output matrix.

FIG. 13 illustrates an example output graph.

FIG. 14 illustrates an example output graph.

FIG. 15 illustrates an example output graph.

FIG. 16 illustrates an example output graph.

FIG. 17 illustrates an example output graph.

FIG. 18 is a schematic block diagram of an example computing environment with which the example systems and methods can interact.

FIG. 19 illustrates an example filter adding page on an example GUI.

FIG. 20 illustrates an example synonym editor page on an example GUI.

FIG. 21 illustrates an example synonym grouping page on an example GUI.

FIG. 22 illustrates an example citation tree page on an example GUI.

### DETAILED DESCRIPTION

Example methods and systems are now described with reference to the drawings, where like reference numerals are used to refer to like elements throughout. In the following description, for purposes of explanation, numerous specific details are set forth in order to facilitate thoroughly understanding the methods and systems. It may be evident, however, that the methods and systems can be practiced without these specific details. In other instances, well-known structures and devices are shown in block diagram form in order to simplify description.

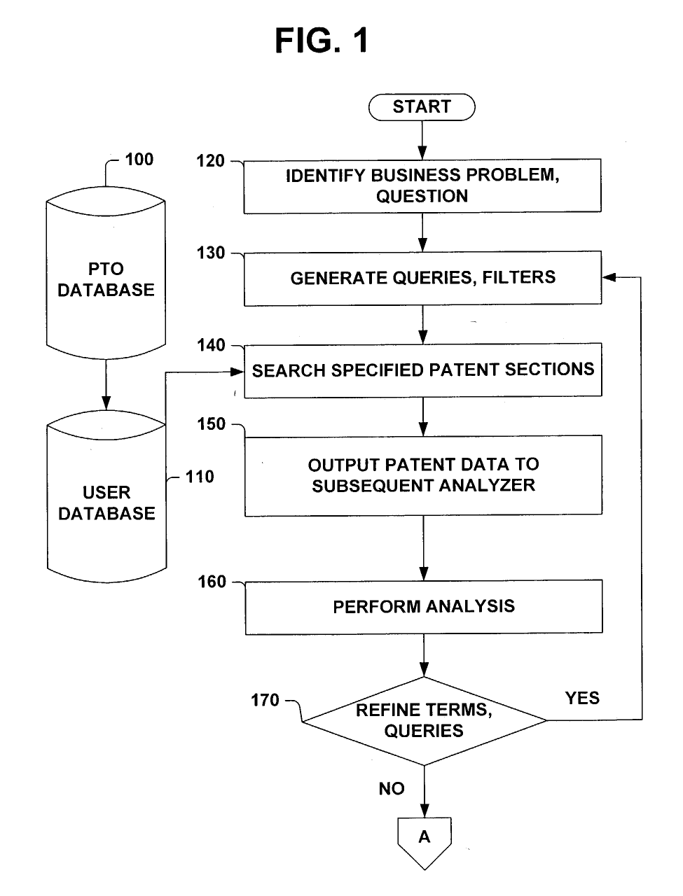

In view of the exemplary systems shown and described above, methodologies that are implemented will be better appreciated with reference to the flow diagrams of FIGS. 1 through 7. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks. In one example, methodologies can be implemented as computer executable instructions and/or operations, which instructions and/or operations can be stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an ASIC, and the like.

A flow diagram does not depict syntax for any particular programming language, methodology, or style (e.g., procedural, object-oriented). Rather, a flow diagram illustrates functional information one skilled in the art may employ to program software, design circuits, and so on. It is to be appreciated that in some examples, program elements like temporary variables, initialization of loops and variables, routine loops, and so on are not shown. Furthermore, while some steps are shown occurring serially, it is to be appreciated that some illustrated steps may occur substantially in parallel.

FIG. 1 is a flow chart that illustrates a portion of an example method for data mining. The data mining may occur, for example, in patent data. A database 100, for example a U.S. Patent and Trademark Office database, is initially downloaded into a user database 110. The database 110 is then periodically updated through incremental downloads from the database 100. The user database 110 can be reformatted to be more readily searchable by, for example, an SQL query. At 120 a business problem is identified. For example, questions like “what is happening in a certain technological area”, or “should we develop or license technology in an area” are formulated. From the problem formulations, at 130, a set of query terms, and queries are generated. These query terms, and queries are determined, at least in part, by the nature and capabilities of the search engine(s) employed to search the database 110. While conventional systems may employ a simple key word based approach to retrieving patents, the example systems and methods described herein facilitate producing more sophisticated queries that facilitate cross tabulating retrieved documents.

At 140, specified sections (e.g., background section) of patents in the user database 110 are searched. Example techniques including, but not limited to, pattern matching and table look-ups can be employed. At 150, data retrieved in the search of 140 is output in a format that facilitates subsequent analyses. For example, words, phrases, sentences, and/or paragraphs can be output in forms including, but not limited to, tables, tab delimited fields, space delimited fields, carriage return delimited fields, and so on.

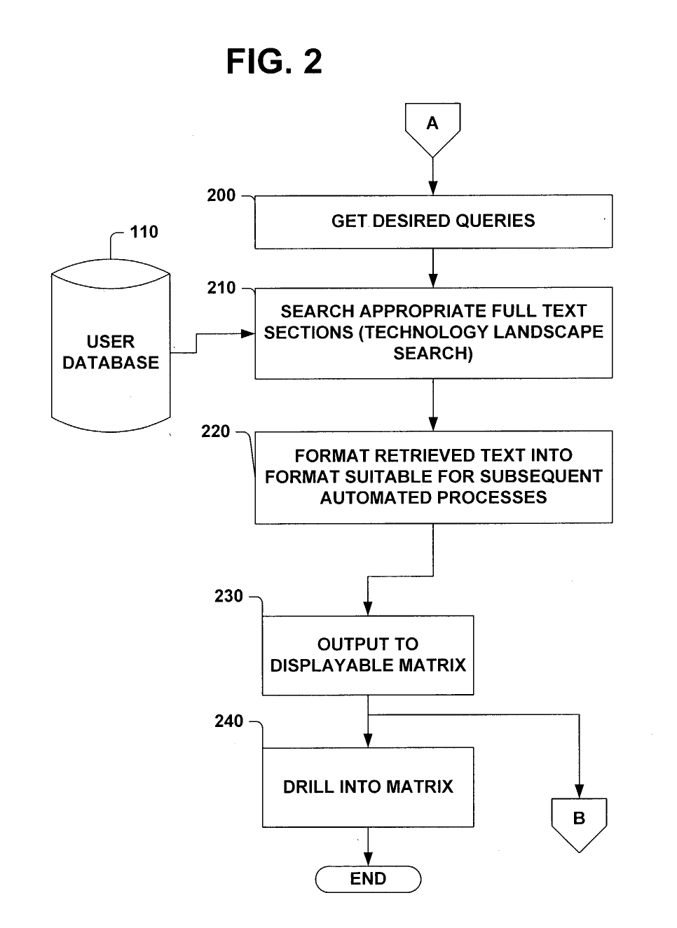

At 160, the data is analyzed by one or more automated processes (e.g., pattern matters, technical attribute identifiers) to facilitate determining, for example, relevant concepts and/or useful search terms to expand the query. This provides advantages over conventional systems that require manual interaction (e.g., reading) by a patent reviewer to locate relevant concepts and/or useful search terms. At 170 a determination is made whether to refine or generate new terms and/or queries. If the determination at 170 is yes, processing returns to 130, otherwise processing advances to connector A which is located at the top of FIG. 2.

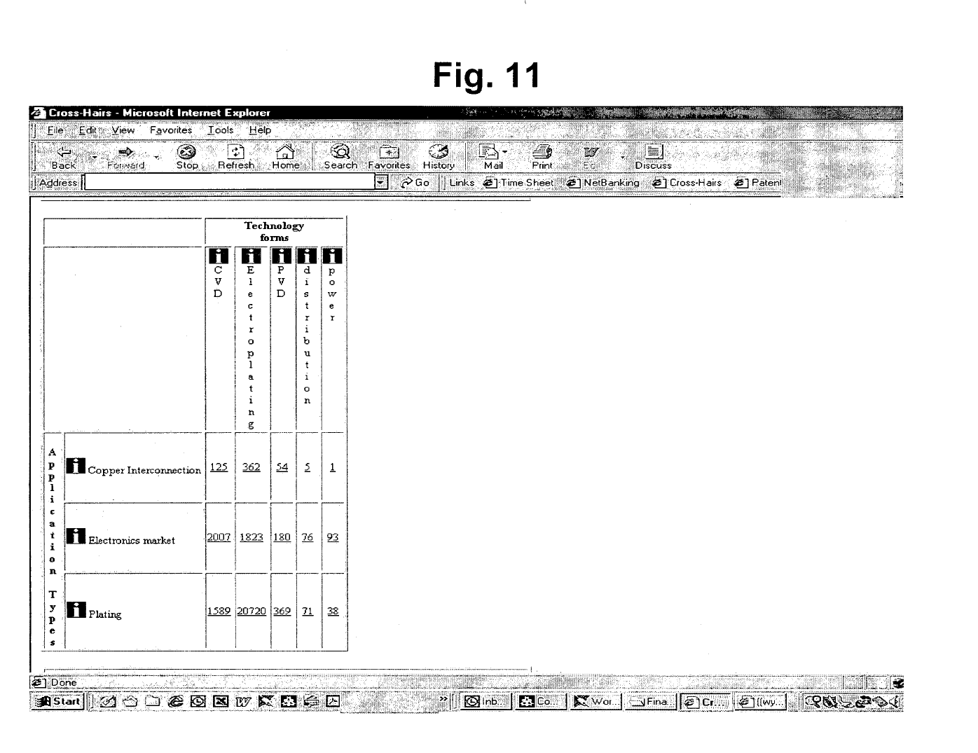

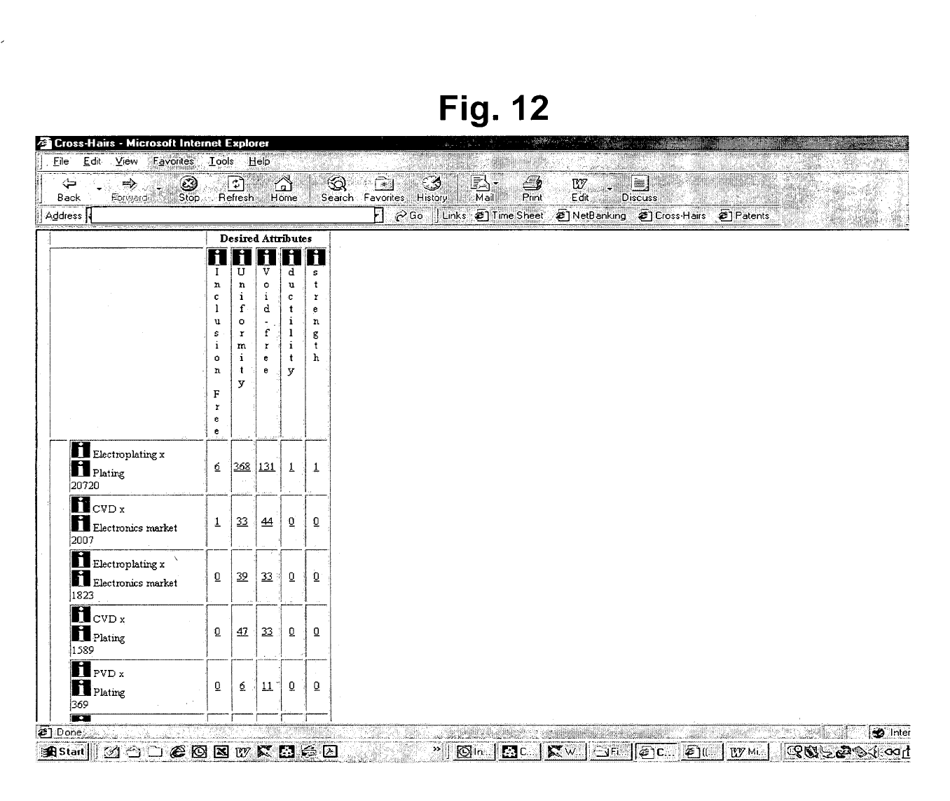

FIG. 2 is a flow chart that illustrates a portion of an example method for data mining. In one example, the data mining is performed in a patent document database. The method picks up from the bottom of FIG. 1 and accesses the user database 110. At 200, query terms and queries are accessed. At 210, desired sections of the full text of patents are searched (e.g., pattern matched). At 220, patents retrieved from the user database 110 are selectively reformatted and stored in a searchable database. This facilitates inputting data from the retrieved patents to subsequent automated analyzers to expand search terms sets and to format the data for spreadsheet like graphing. At 230, data retrieved from the patents is output to, for example, a displayable matrix. This matrix facilitates identifying correlations, trends, and cross-references between patents. Example output matrices are provided in FIGS. 11 and 12. At 240, a user can drill into the matrix to retrieve information from the intersection of attributes.

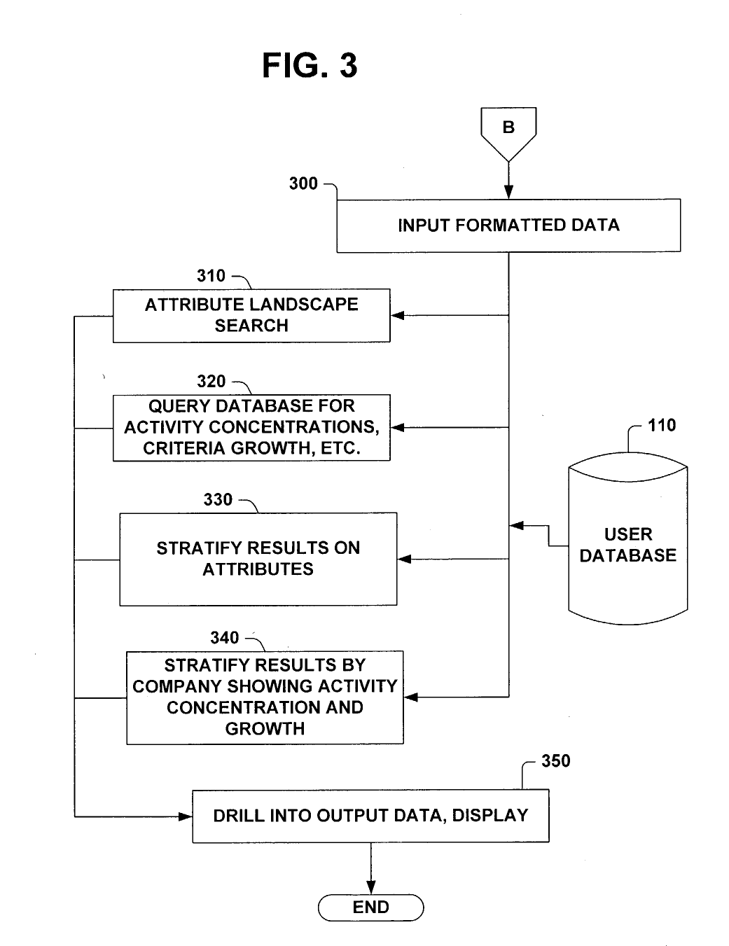

Turning now to FIG. 3, a flow chart illustrates a portion of an example method for data mining. The data mining may occur, for example, in patent data (e.g., USPTO database). The portion begins at connector B which picks up from the bottom of FIG. 2. At 300, formatted data is input. A subsequent search of documents contained in the previous matrix for technical specifications (e.g., identifying documents with desired textual and/or numerical values) occurs. For example, ranges of temperatures, revolutions per minute, thresholds, database sizes, and engineering tolerances may be identified using the matrix analysis method. From 300, one or more substantially parallel paths maybe taken. At 310, cross tabulated results are produced and/or displayed, for example, in a matrix. Example matrices are provided in FIGS. 11 and 12. At 350, a user may drill into the matrix to examine data employed to create the matrix. Drilling into the matrix may involve, for example, selecting a cell in the matrix (e.g., clicking on it) and receiving the data used to deposit a patent in that cell.

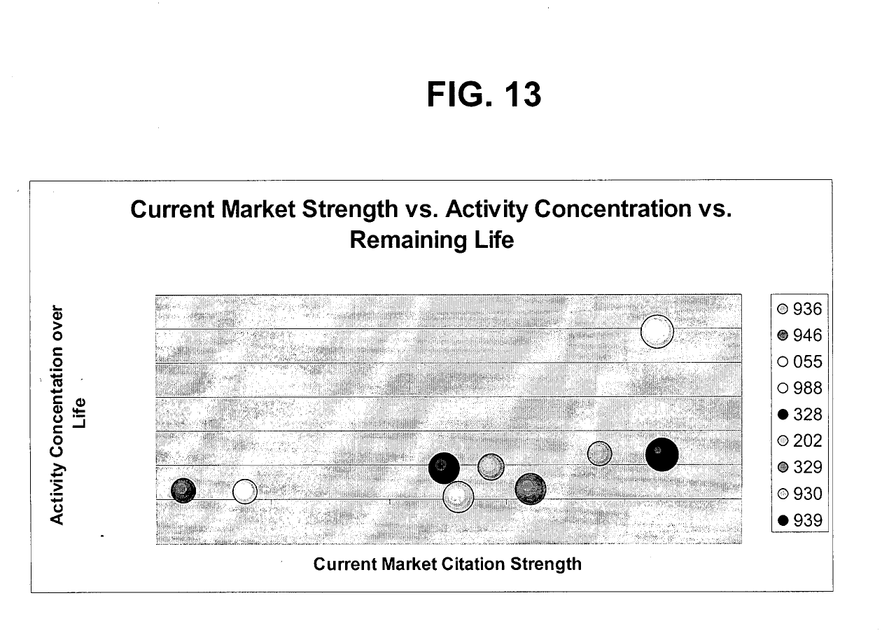

Rather than immediately displaying cross tabulated results, the method may query the user database 110 for activity concentrations and citation growth, for example. While this query is illustrated at 320, it is to be appreciated that this query may occur at other times. The method may also query the user database 110 for other information that facilitates producing a graphical display for interpreting retrieved data which in turn facilitates arriving at answers to business questions. Examples of graphical displays that facilitate readily understanding retrieved data are provided in FIGS. 13 through 17.

At 330, the method may stratify patent data results on one or more attributes, and display, for example, the presence of an attribute. An attribute can be, for example, a descriptive and/or characterizing data like a temperature, a temperature range, a color, a size, a size range, a velocity, a velocity range, and so on. Stratification facilitates producing a graphical matrix display (e.g., the Attribute Detail Matrix 390) that in turn facilitates more readily interpreting the results of searches and producing answers to business questions.

At 340, the method stratifies results, for example, by company, showing activity concentration and growth. This again facilitates producing a graphical display that simplifies interpreting the results of patent searches. In both 330 and 340, the method proceeds to 350 where a user may drill into the display to retrieve information employed in creating the display. This information may be useful in determining cross references and/or links between data, for example.

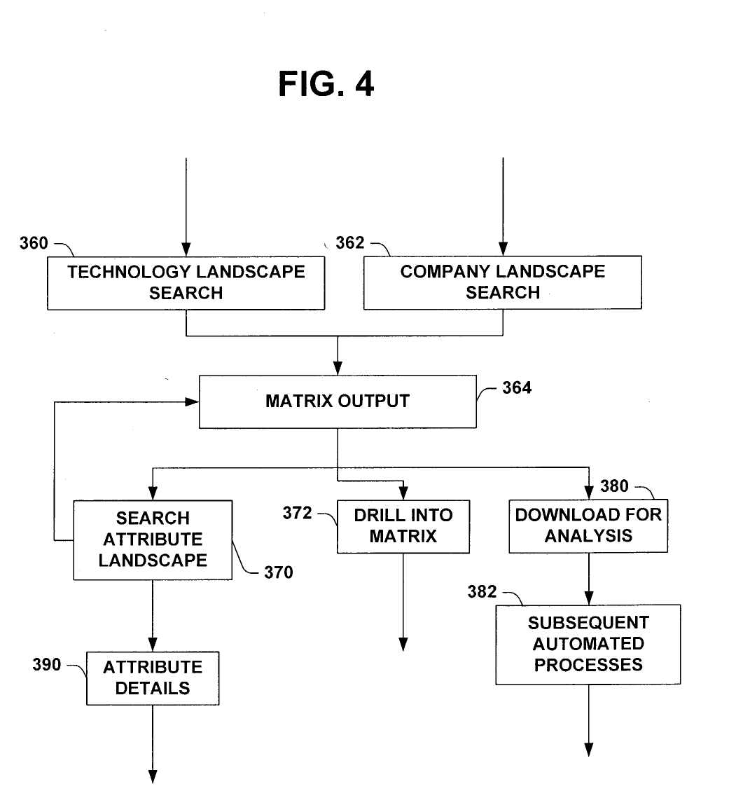

FIG. 4 illustrates a portion of another example data mining method. The data mining may occur, for example, in patent data like the USPTO patent database. At 360 and 362, substantially parallel tasks can occur. For example, at 360, a technology landscape is searched while at 362 a company landscape is searched. The output of either search can then be presented in a matrix output format at 364. At 370, an attribute landscape is searched. From 370, two substantially parallel paths are possible. On a first path, the attribute landscape results are output in a matrix at 364. On a second path, at 390, the attribute details are examined. At 372, a user may drill into the matrix output from 364 to examine data upon which the matrix was constructed. At 380, data upon which the matrix was constructed is stored in data stores in a format that simplifies subsequent automated processing like that at 382. Thus, FIG. 4 illustrates a searching, displaying, drilling down, and analysis feedback loop that simplifies an iterative processing for initially mining patent data and then successively refining the data mining until visible solutions to business problems are achieved.

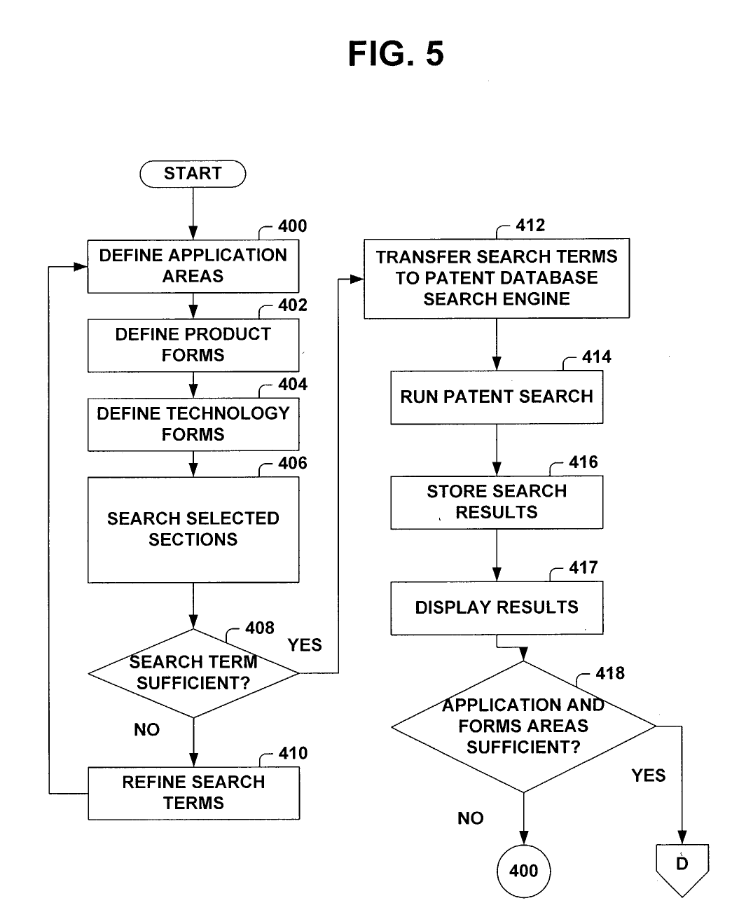

Turning now to FIG. 5, a flow chart illustrates another example method for data mining. The data mining may occur, for example, in patent data. At 400, one or more application areas for which the reviewer seeks information are defined. Example application areas are, automotive, particle density, and so on. Based, at least in part, on the application areas defined at 400, at 402, one or more forms in which the products associated with the application area can be found are defined. Example product forms are, for example, oxygen sensor, tachometer, and so on. Similarly, at 404, based on the application areas and/or product forms, one or more technology forms are defined. An example technology form is hall effect or capacitive.

At 406, queries generated in response to the definitions of the application areas, product forms, and technology forms are run and desired sections of patents are examined to identify relevant concepts and/or matching search terms. At 408, a manual determination is made concerning whether the search terms used to this point in the method are sufficient. For example, if a large number of irrelevant patents are retrieved, then this may signal that the search terms should be refined. Thus, if the determination at 408 is no, then at 410, the search terms are refined. Processing then returns to 400. If the determination at 408 is yes, then processing continues at 412.

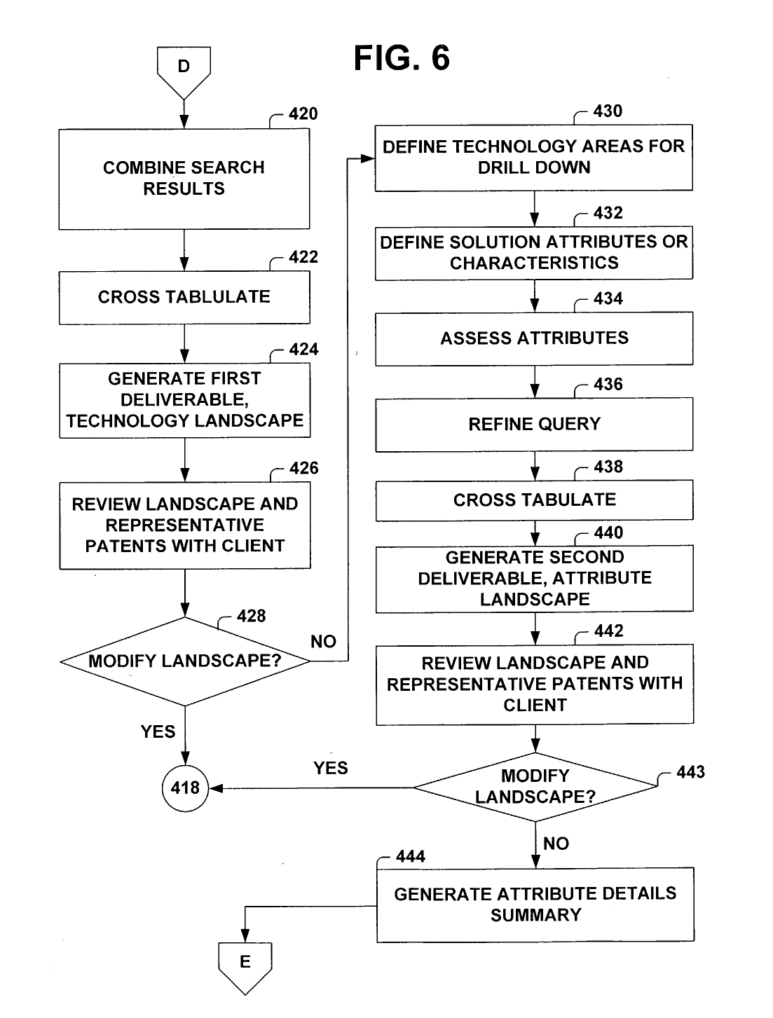

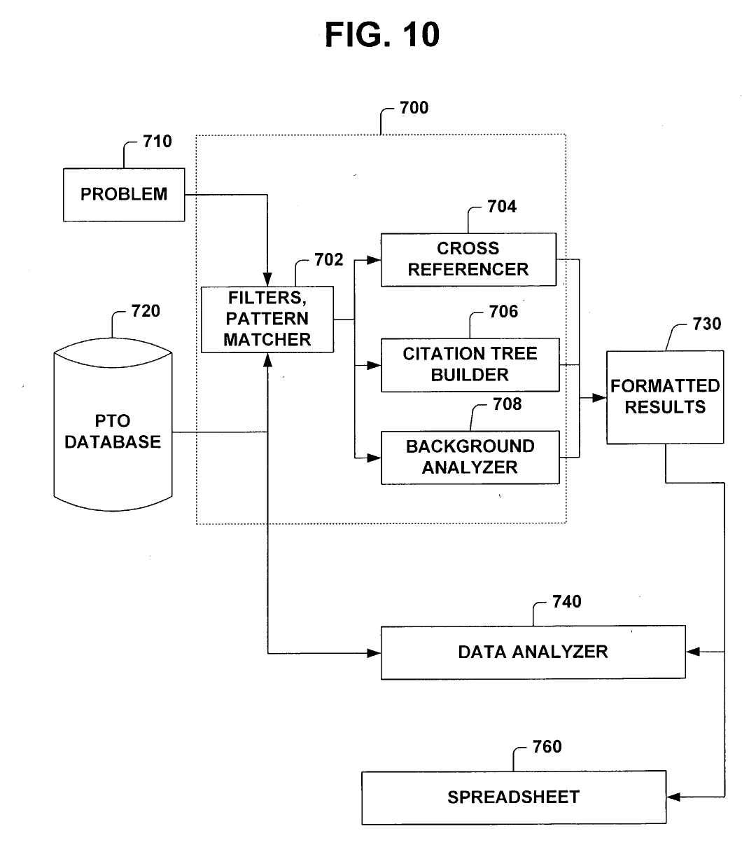

At 412, search terms are transferred to a patent database search engine. Then, at 414, a patent search is run against the database. At 416, the search results are stored in a form that facilitates subsequent automated analysis. The subsequent automated analysis can be performed by, for example, a data analyzer 740 (FIG. 10) for search term expansion and a spreadsheet 760 (FIG. 10) for spreadsheet like graphing. At 417, the results can be displayed. It is to be appreciated that displaying the results facilitates drilling down into the data upon which the graphical displays are built. At 418, a manual determination is made concerning whether to refine the application areas and product forms. For example, the determination can be based, at least in part, on whether the results returned from the patent search at 414 produced a sufficient number of patents for meaningful statistical analysis. If the determination at 418 is no, then processing returns to 400. Otherwise, processing continues at 420 (FIG. 6).

Referring now to FIG. 6, at 420, the search results for one or more queries are combined to facilitate cross tabulating data. The cross tabulations simplify visualizing information useful to analyzing business problems. At 424, a first deliverable, a “technology landscape” is produced. The technology landscape describes intersections between attributes employed to partition a technology, technologies, markets, applications and/or products, for example.

At 426, the technology landscape can be reviewed, along with representative patents, with the business client for whom the analysis is being performed. Therefore, it is evident that the method described in FIGS. 5, 6 and 7 can include both computerized and manual aspects. At 428, a determination is made whether to modify the landscape. If the determination at 428 is yes, then processing returns to 418 (FIG. 5). Otherwise, if the determination at 428 is no, then processing proceeds to 430.

At 430, technology attributes for which the client desires greater refinement are identified. The method then drills down into identified technology attributes to facilitate producing a more sophisticated information analysis useful to solving a business problem. At 432, solution attributes (e.g., temperature, life cycle) are defined. One method for defining attributes or characteristics is to produce sets of query terms and/or queries that describe the attributes desired in a solution. At 434, the attributes are assessed to facilitate determining whether to refine the attributes.

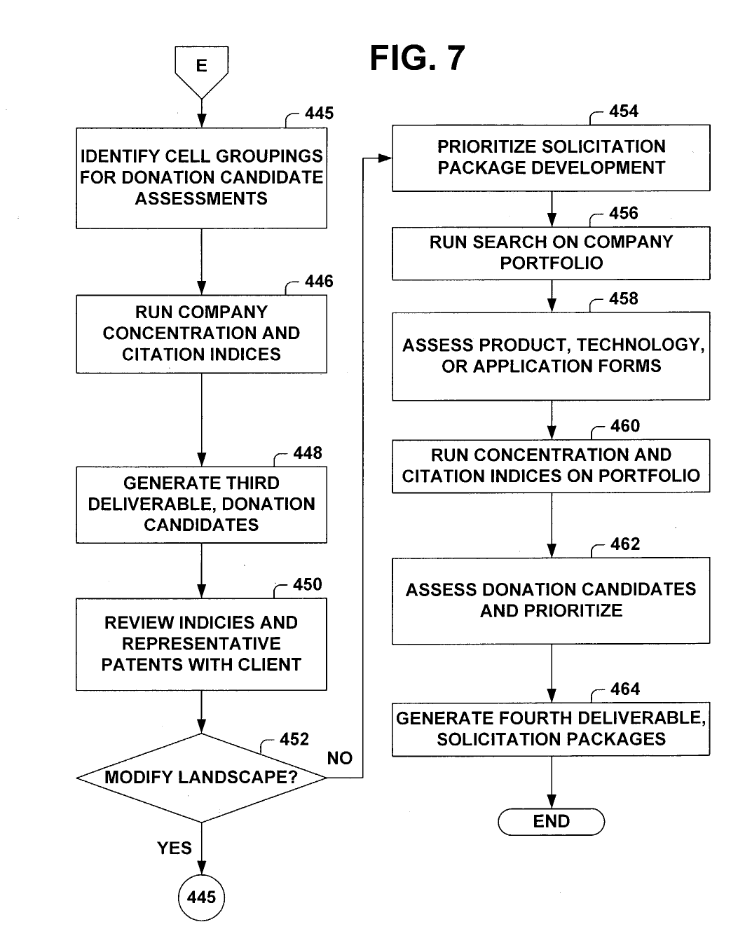

At 436, based on the results of the analysis of 434, the attributes may be refined. Then, at 438, cross tabulations of attributes, forms, and application areas can be created. At 440, a second deliverable is produced. This deliverable is an attribute landscape. At 442, the manual step of reviewing the landscape and representative patents with the client is undertaken. Step 442, like step 426, provides opportunities for the reviewer and the client to determine the applicability of the results to the business problem. Thus, rather than a search simply providing a client and/or reviewer with a list of patents, the method described in FIGS. 5, 6, and 7 facilitates producing cross referenced, viewable high level data that simplifies interpreting the results of patent searches. At 443, a determination is made whether to modify the landscape. If the determination at 443 is yes, then processing returns to 418, otherwise, if the determination is no, processing proceeds to 444 (FIG. 7). At this time, a list of patents and an attribute details summary is created.

FIG. 7 illustrates actions taken as part of an example method for patent data mining. For example, at 445, groupings of patents are identified as candidates for donation assessments. By way of illustration, if a patent shows market interest but no longer supports the company's strategic interests, then the patent may have limited value to the patent holder. Thus, the patent holder may consider transferring the patent to the public domain in return for other consideration (e.g., good press, goodwill, tax advantages). Similarly, if a patent has outlived its usefulness (e.g., numerous workable non-infringing design-arounds have entered the business space), then the patent may have limited value to the patent holder and may be a candidate for abandonment.

At 446, the method runs company concentration and citation indices. This facilitates identifying landmark and/or key patents. By way of illustration, if one patent has been cited thousands of times in subsequent patents, then this patent is likely an important patent with which the reviewer and/or client should be familiar. Similarly, if a company has concentrated its research in a particular area, the analysis at 446 facilitates identifying these areas, which in turn facilitates identifying companies with which a client may wish to interact (e.g., licensing, takeover, merger).

At 448, a third deliverable (e.g., donation candidates) can be produced. Thus, at 450, there is another opportunity for the entity employing the method to interact with the client. The concentration and citation indices along with representative patents and donation candidates can be reviewed with the client. Therefore, at 452, a determination is made concerning whether to modify the landscape. If the determination at 452 is yes, then processing returns to 445, otherwise, if the determination is no, processing proceeds to 454.

At 454, solicitation package development is prioritized. For example, if the processing performed in the method to this point has identified companies with which the employer of the method desires to interact (e.g., sell technology), then a solicitation package may be developed for such a company. At 456, a company portfolio is searched to facilitate determining, for example, pricing and/or terms to include in the solicitation package. Then, at 460, concentration and citation indices on the portfolio for which the solicitation package is being developed are run. At 462, donation candidates can once more be assessed and prioritized.

At 464, a fourth deliverable (e.g., solicitation package) is generated. By way of illustration, the solicitation package may be a business proposal to a company suggesting that the company purchase certain intellectual property of the soliciting party. By way of further illustration, the solicitation package may be a request from a party to the holder of certain intellectual property that the holder of the intellectual property donate that property to the public domain. This type of package may be generated, for example, by charitable organizations or business development consortiums seeking to find opportunities for job creating companies.

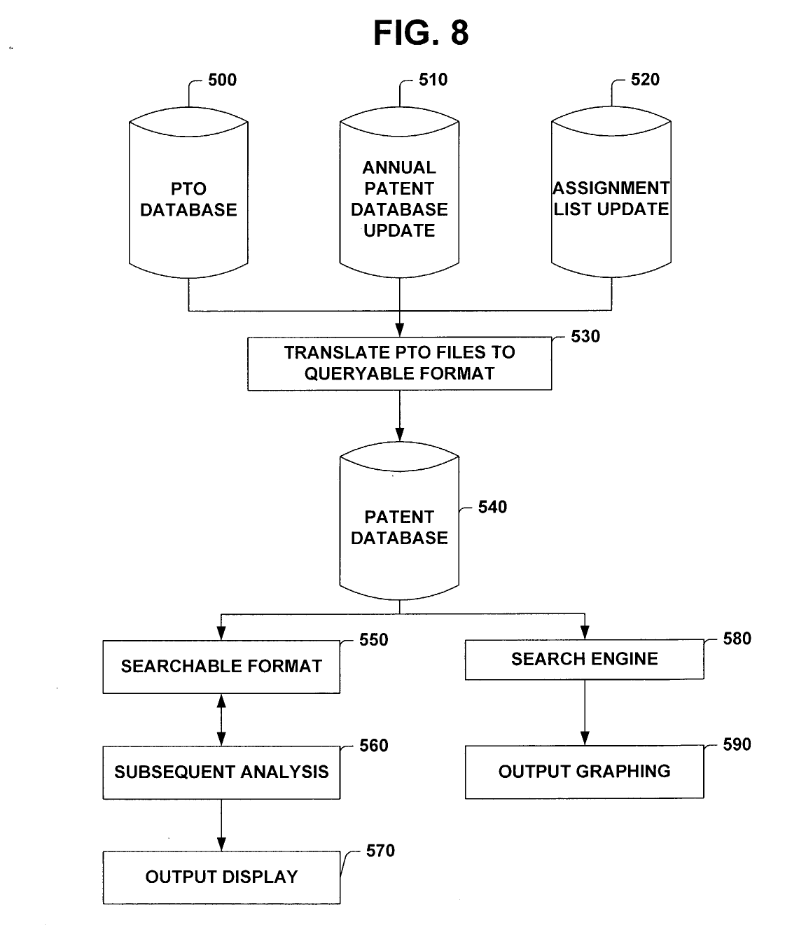

Turning to FIG. 8, a data and process flow for a system and method for data mining is illustrated. The data mining can occur, for example, in patent data like that found in the USPTO patent database. In FIG. 8, the files retrieved from the Patent and Trademark Office (PTO) are translated to an SQL searchable or other searchable file format, which facilitates creating a queryable database. A queryable database facilitates analyzing patent data by tools like search engines.

In FIG. 8, the PTO database 500, annual patent database updates 510, and an assignment list update 520 are translated at 530 to a format that can be queried by a database query tool. A patent database 540 that can be queried is therefore available for subsequent analysis. This is an improvement over conventional systems that simply use a keyword query of the PTO database and produce a list of patents which must then be read by the reviewer or businessperson to retrieve relevant information. The patent database 540 facilitates producing data 550 in a format that is searchable by subsequent automated processes 560, providing advantages over conventional systems where subsequent analysis is performed manually through the expertise of the reviewer and/or subsequent keyword searches.

Additionally and/or alternatively, the patent database 540 can be queried by a search engine 580. Output graphing computer components 590 produce viewable interpretations of information retrieved from patent data which is an improvement over conventional systems where no such similar graphing is possible from simple lists of patents retrieved by text based search engines. The viewable interpretations simplify actions including, but not limited to, determining the patentability of a system or method, performing a right to use study, and answering business questions, for example. The search engine 580 employs techniques like producing proximity relationships, suffix processing, intelligent numeric identification and synonym constructions to produce focused queries.

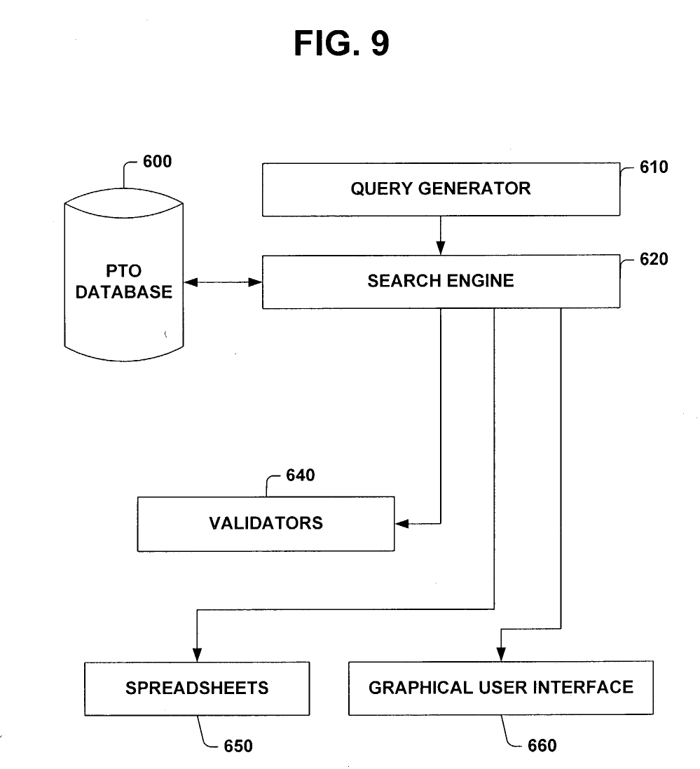

FIG. 9 illustrates an example system for data mining. The data mining may occur, for example, in patent data. The PTO data base 600 is searched by a search engine 620. The search engine 620 inputs a set of queries from a query generator 610. Thus, rather than the search engine 620 performing a single conventional keyword search, the search engine 620 performs a more sophisticated set of searches that facilitates correlating responses. Rather than a reviewer reading the patents retrieved by the search engine 620, at this point further automated processing occurs. This yields an exponential increase in search coverage resulting from cross tabulating searches.

Validators 640 analyze validation criteria to verify the scope of the search. Validation can be a manual search derived from patents the client believes should be found in a valid search. When doing validation, a validator 640 will have an idea about what a valid search should return. For example, when searching for patents on topic X, a valid search may be required to return at least patents x1, x2 and x3. Thus, when formulating a query or a series of cross tabulated queries, a validator can test the query or series of cross tabulated queries by performing a search using the query or series of queries and seeing whether it returns the expected patents. Similarly, a validator may know that a valid search should not contain certain patents. Thus the validity of a search can be tested by performing a search with the query and identifying that the offensive patents were not returned. Once a valid query and/or series of queries has been generated, data can be deposited, for example, in a spreadsheet 650.

While this example illustrates a spread sheet 650, it is to be appreciated that in other example systems the output of the search engine 620 may be deposited in other data storage formats (e.g., files, tables, database tables). The graphical user interface 660 can extract data from the spread sheet 650 or other data stores to facilitate producing, for example, matrices and other visual displays (e.g., spreadsheet like graphs) that simplify interpreting data retrieved from the patents. Thus, rather than a conventional list of patents that must be read by a reviewer in an attempt to extract information responsive to a business problem, the example system illustrated in FIG. 9 simplifies retrieving data by analyzing (e.g., validating, graphing) data retrieved from the patent database 600 and by simplifying the display of graphical data associated with search analyses.

FIG. 10 illustrates one example system for data mining in patent data. The system includes a computer component 700 that includes filters 702 employed in pattern matching, a patent citation cross referencer 704, a citation tree builder 706, and a background analyzer 708. Once a business problem 710 has been identified, queries associated with extracting information useful to solving the business problem 710 are generated. An example query generated by the computer component 700 takes the form:

vapor deposition within 5.

Since patents may reference other patents, a patent citation cross referencer 704 generates data suitable for displaying cross references. Similarly, a citation tree builder 706 examines patent data 720 and produces formatted data 730 that facilitates displaying the citation genealogy of patents. A background analyzer 708 analyzes patent data 720 to facilitate assessing the relevance of patent data 720. The cross referencer 704, citation tree builder 706, and background analyzer 708 produce formatted results 730 (e.g., tab delimited fields, space delimited fields, carriage return delimited fields) that are suitable for input to subsequent automated processes. These subsequent automated processes can include, but are not limited to, a data analyzer 740 for search term expansion, and a spread sheet 760.

FIG. 11 is an example matrix output produced by example systems and methods described herein. The simulated screen shot displays a matrix of the intersection between technology forms and application types. For example, the intersection between chemical vapor deposition (CVD) and copper interconnections produced 125 patents. It is to be appreciated that the definition of chemical vapor deposition is not simply a keyword search, but is the result of a set of searches associated with a set of query terms and queries associated with the systems and methods described herein. Thus, unlike conventional systems that produce a matrix that is the result of “intersection anding” of two single query terms (e.g. a single keyword), the matrices produced by the example systems and methods described herein illustrate the intersection of two or more sets of related queries that characterize concepts (e.g., technology form, application type, desired attributes) and thus employ higher level data. Similarly, a simple keyword search for “copper interconnection” is generally not performed by the systems and methods described herein. Rather, a set of query terms and queries including terms to include, terms to exclude, synonyms, stems and other items are employed to extract patents identified with copper interconnection. This is an improvement over conventional matrix displays that simply show the intersection of first level data like patents that both have term A and term B. The matrix illustrated in FIG. 11 illustrates the simplicity with which the intersections of attributes that bear on business problems can be interpreted. For example, if a company were examining a technological area for opportunities to acquire licenses for technology, then it would be more likely that a license would be available that concerns electroplating in the electronics market than distribution in the electronics market since there are 1,823 patents from which to choose rather than 76 patents.

FIG. 12 illustrates a matrix of the intersection of desired attributes with the aggregation of the intersection of technology forms and application types from FIG. 11. The matrix facilitates identifying areas in which a reviewer can focus further research. For example, there appears to be more information concerning uniformity in the electroplating by plating intersection (e.g., 368 patents) than in the PVD by plating (e.g., 6 patents) field. This may indicate, for example, that issues of uniformity in the electroplating by plating field have been rigorously examined and patented while issues of uniformity in the PVD by plating field may be a relatively new technology. This may identify, for example, a field in which a company may wish to perform basic research. Furthermore, this may identify the relative worth of the development of a new technology in the uniformity field based on the aggregation area into which the technology applies. Conventional systems that simply generate a list of patents provide no similar information and do not facilitate similar analyses. Similarly, conventional systems that simply produce a matrix illustrating the intersection anding of query terms do not take the additional steps of intersecting higher level concepts like desired attributes. For example, the concept “uniformity” illustrated in FIG. 12 can be characterized or modeled by a set of queries with numerous inclusions, exclusions, ranges, and so on. Thus, higher level data like uniformity is cross-referenced with even higher level data like the intersection of two high level concepts (e.g., CVD×plating).

Turning now to FIG. 13, a spreadsheet like graph example provides a visual display of information that facilitates understanding a business analysis. Information concerning the relationship of a patent to three different variables is presented in FIG. 13. A first variable, activity concentration over life, is plotted along the y axis of the graph. A second variable, current market citation strength, is plotted along the x axis of the graph. A third variable, remaining life, is plotted by altering the size of the circle that represents the patent for which activity concentration and current market citation strength are plotted. Thus, in the lower left hand corner of the plot, the '329 patent has a relatively shorter remaining life as compared to the patent in the top right hand corner, the '055 patent. The difference in relative remaining lives is evident based on the larger size of the circle for the '055 patent as compared to the '329 patent. Patents that are listed on the left hand side of FIG. 13 have a relatively weak market citation strength, meaning they have been cited less frequently in the relevant market. Conversely, patents listed on the right hand side of FIG. 13, have a relatively stronger current market citation strength indicating that they have been cited more frequently in the relevant market. Patents listed near the top of FIG. 13 have a relatively larger activity concentration over their lifetime as compared to patents listed along the bottom of FIG. 13. Thus, FIG. 13 provides a spreadsheet like graphical output of information retrieved from patents, rather than a simple list of patents providing improvements over conventional systems. While FIG. 13 illustrates one combination of attributes plotted in x, y, and size dimensions, it is to be appreciated that other spreadsheet like graphical representations can convey information in different manners. The visual display illustrated in FIG. 13 may be referred to as a “bubble plot”, where the bubbles are various sized circles on the graph. Conventional systems produce single line graphs or bar charts derived from first level data (e.g., raw citation count, intersection anding, relevance score). The bubble plot shown in FIG. 13 illustrates three dimensions of data, where one or more of the dimensions is second level or “higher level” data (e.g., citation concentration over time, current market strength). Thus, the bubble plot facilitates a more in depth visual analysis of business problem solving data, which facilitates answering business questions. While current market strength, activity concentration, and remaining life are illustrated and related in FIG. 13, it is to be appreciated that other high level conceptual data derived from patent data mining can be displayed.

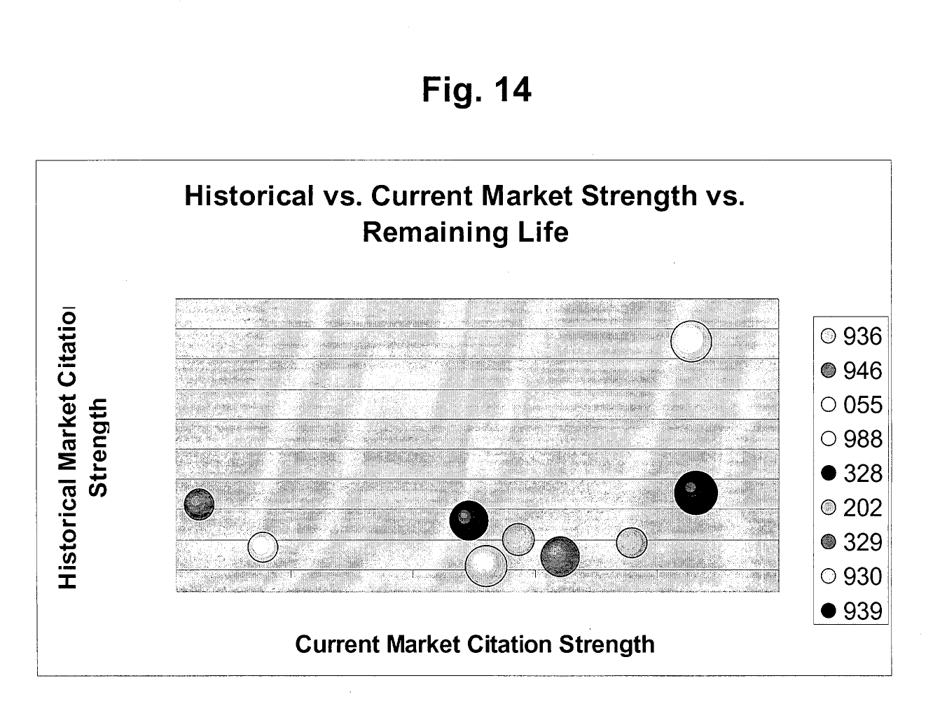

FIG. 14 is another example of the readily interpretable visualizable data that can be produced by example systems and methods described herein. FIG. 14 illustrates a multi-dimensional spreadsheet like graphical output. FIG. 14 plots the historical market citation strength of a patent against the current market citation strength of a patent and further conveys information concerning the remaining life of a patent. The historical market citation strength of a patent is illustrated by relative position on the y axis. For example, the '055 patent, positioned in the top right hand corner of FIG. 14, has had a relatively greater historical market citation strength as compared to the '329 patent that is listed in the lower left hand corner of FIG. 14. This indicates that the '055 patent has remained a relatively frequently cited patent over its lifetime while the '329 patent has been cited relatively fewer times. Similarly, the '055 patent is listed on the right hand side of FIG. 14 indicating that it has recently been frequently cited. Conversely, the '329 patent listed on the left hand side of FIG. 14 has not recently been frequently cited. This may indicate that the '055 patent is a “key” patent to which a reviewer and/or a business person should pay close attention. FIG. 14 also conveys information concerning the remaining life of a patent. Once again, the '055 patent has a relatively longer remaining life as compared to the '329 patent displayed in the lower left hand corner of FIG. 14. Thus, not only has the '055 patent been frequently cited historically, and is currently being frequently cited, but it has a relatively longer remaining life. This information has been analyzed from the patents retrieved in response to the sets of queries generated and employed by the systems and methods described herein without manual patent reading by a reviewer. Thus, rather than wading through a lengthy list of patents in an attempt to gather information applicable to the solution of a business problem, the reviewer and/or business person refers to graphical displays like that illustrated in FIG. 14 to identify patents to which their time will be applied. While FIG. 14 illustrates one combination of attributes plotted in a plurality of dimensions, it is to be appreciated that other spreadsheet like graphical representations can convey information in different manners. Similarly, while historical market citation strength, current market citation strength, and remaining life are illustrated, it is to be appreciated that other high level abstracted data may be displayed.

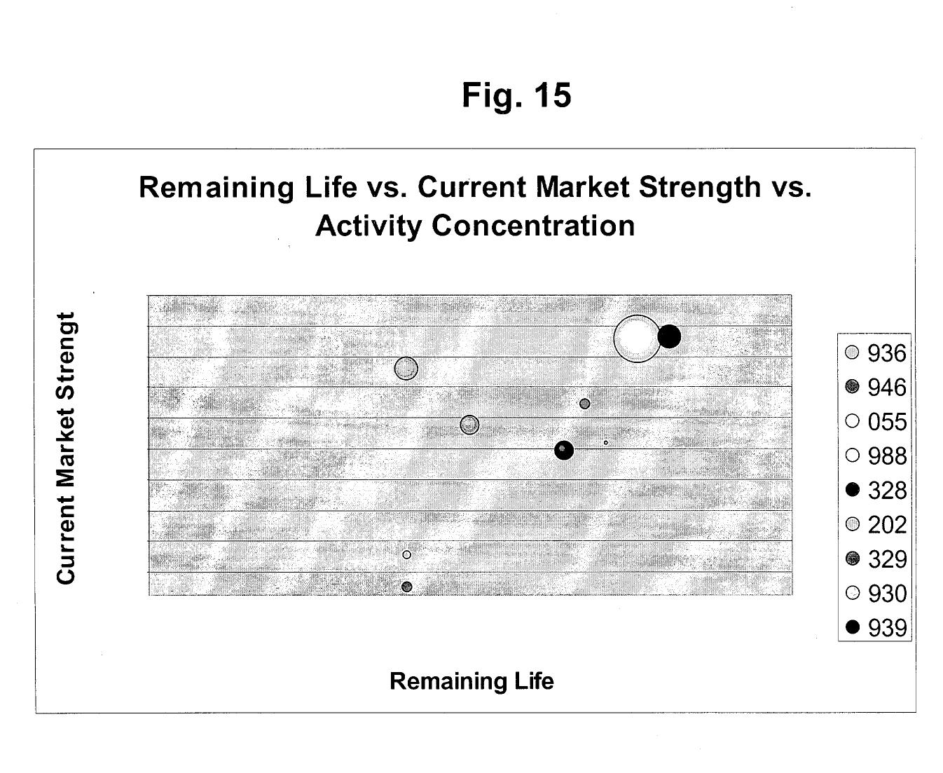

FIG. 15 is another example of a multi-dimensional spreadsheet like graph produced by the example systems and methods described herein. FIG. 15 plots the current market strength of a patent along the y axis, the remaining life of a patent along the x axis, and the activity concentration of a patent through the size of the circle representing the patent. Thus, it is visually evident when viewing the circles in FIG. 15 that the '055 patent listed in the upper right hand corner (in the largest circle) warrants more attention from the business person who is interested in the interaction between current market strength, remaining life, and activity concentration, than does the '329 patent that is listed in the bottom center of FIG. 15 (in a very small circle). The location at the top of the chart (indicating a relatively large current market strength), the location at the right hand side (indicating a relatively larger remaining life), and the size of the circle (indicating a relatively large activity concentration) are visually understood without having read the '055 patent. Thus, rather than wading through the text of a number of patents retrieved by a conventional search engine, a patent reviewer can examine FIG. 15 and prioritize the order in which patents retrieved by a search engine will be read, if they are considered at all. Similarly, instead of wading through a series of first level data (e.g., raw counts, single term query results) intersection matrices and/or line charts derived therefrom, a bubble plot of higher level data is consulted and analyzed. The richer bubble plot display conveys information derived from data retrieved from the exponential increase in search coverage that results from cross-tabulating searches. While FIG. 15 illustrates one combination of attributes plotted in x, y, and size dimensions, it is to be appreciated that other spreadsheet like graphical representations can convey information in different manners. Similarly, while remaining life, current market strength, and activity concentration are displayed, it is to be appreciated that other higher level data can be displayed via a bubble plot.

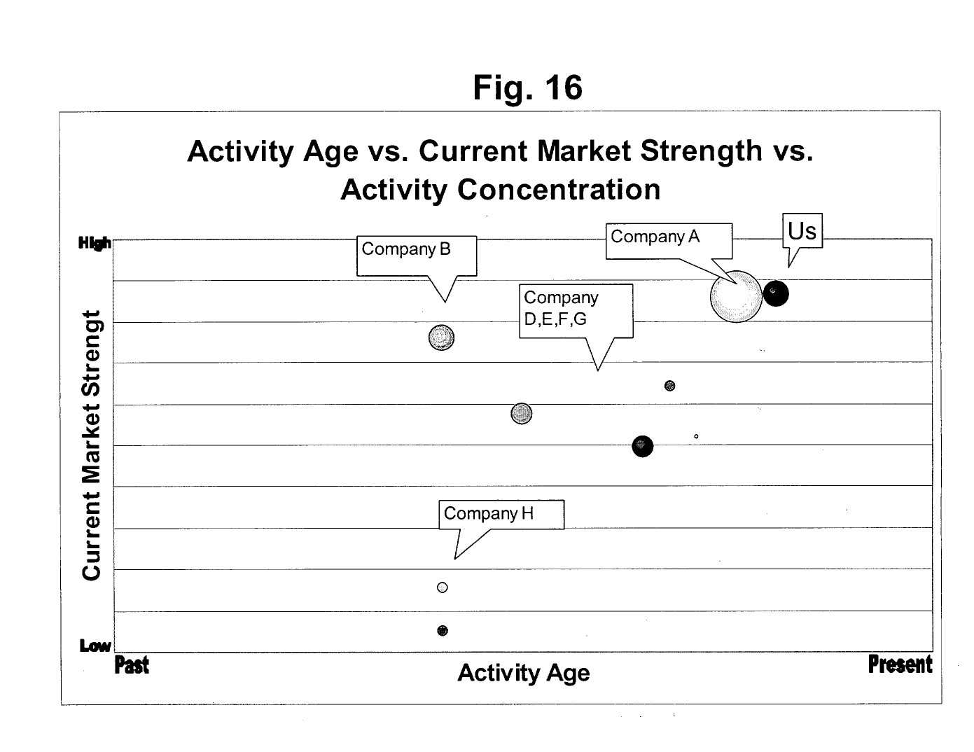

FIG. 16 illustrates yet another example spreadsheet like graphical display produced by example systems and methods described herein. In FIG. 16, rather than displaying individual patents, information concerning patent portfolios for various companies are plotted. The current market strength is plotted along the y axis, the activity age is plotted along the x axis, and the size of the circle for a company indicates the activity concentration. Again, this illustrates improvements over conventional systems that produce line or bar graphs of first level data. Here, higher level data has been aggregated for a company to facilitate comparing companies. Without having read the patents held by Companies A through H, a person viewing FIG. 16 visually understands that there is a large difference between the current market strength, activity age, and activity concentration for Company A as compared to the same parameters for Company H. Thus, a business person may prioritize the companies with which business talks should occur, and/or determine who the competitors are in a technological area. This provides advantages over conventional systems wherein similar information can only be gained after the laborious reading of lists of patents retrieved by conventional search engines and/or examining potentially confusing charts (e.g., bar graphs, line graphs). While FIG. 16 illustrates one combination of attributes plotted in x, y, and size dimensions, it is to be appreciated that other spreadsheet like graphical representations can convey other similar high level aggregated information in different manners.

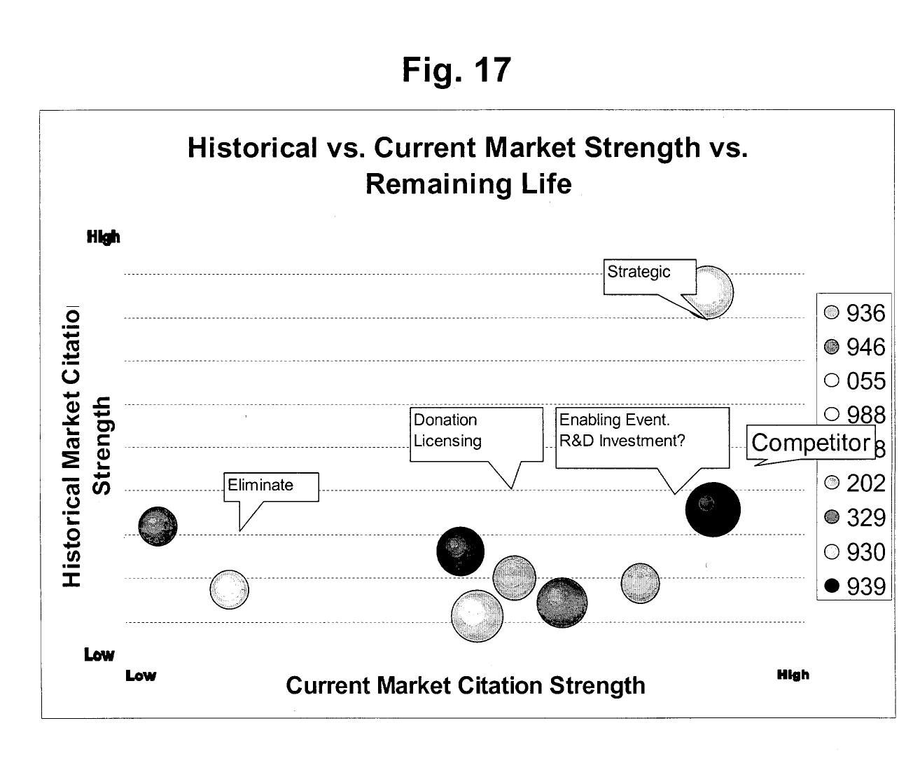

Turning now to FIG. 17, another example spreadsheet like visual display of information retrieved by the example systems and methods described herein is provided. The circles displayed in FIG. 17 are annotated with interpretation information. The historical market citation strength is plotted along the y axis, the current market citation strength is plotted along the x axis, and the remaining life of a patent is depicted by the size of the circle representing the patent.

As an example of interpretations applied to the data presented in FIG. 17, patents located in the lower right hand quadrant of FIG. 17 may be identified as areas in which research and development investment should occur. By way of illustration, a large circle in the bottom right hand corner of FIG. 17 indicates that there has been a relatively high current market citation strength for a patent while there has been a historical low market citation for the patent. This may indicate that a new technology has emerged and that new technology is being cited relatively frequently. If the information in FIG. 17 is correlated with other information (e.g., number of applications filed in a technological area), then business decisions on whether to spend research and development dollars may be made. While FIGS. 13-17 provide various examples of spreadsheet like graphical displays produced by the example systems and methods described herein, it is to be appreciated that other spreadsheet like graphical displays correlating other variables may be produced by the example systems and methods described herein.

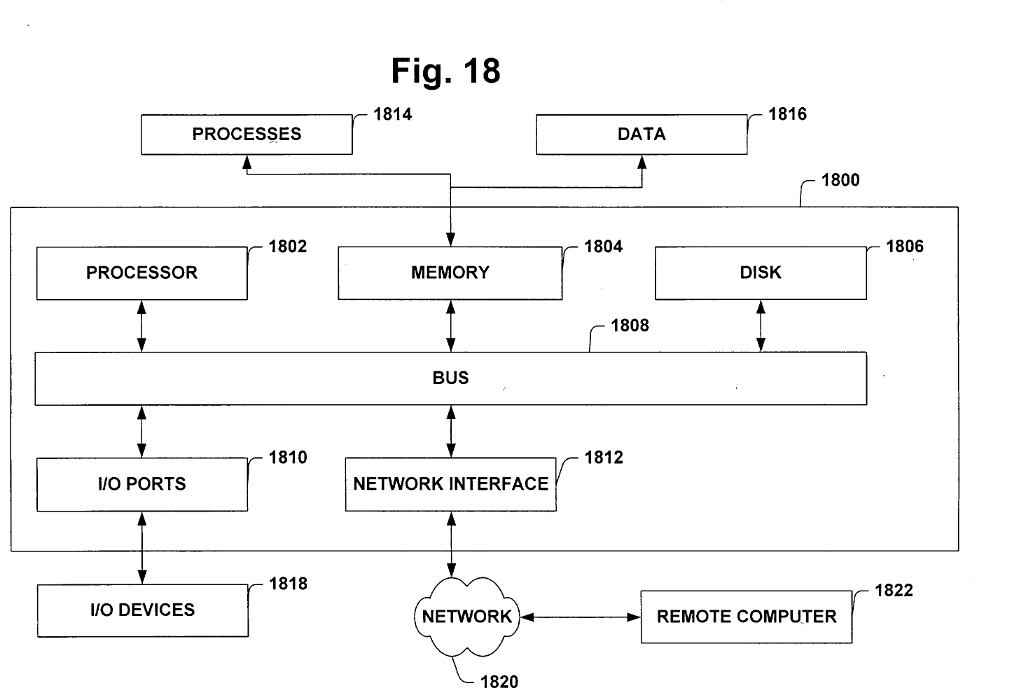

FIG. 18 illustrates a computer 1800 that includes a processor 1802, a memory 1804, a disk 1806, input/output ports 1810, and a network interface 1812 operably connected by a bus 1808. Executable components of the systems described herein may be located on a computer like computer 1800. Similarly, computer executable methods described herein may be performed on a computer like computer 1800. It is to be appreciated that other computers may also be employed with the example systems and methods described herein. The processor 1802 can be a variety of various processors including dual microprocessor and other multi-processor architectures. The memory 1804 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1806 can include, but is not limited to, devices like a magnetic disk drive, a floppy disk drive, a tape drive, a Zip drive, a flash memory card, and/or a memory stick. Furthermore, the disk 1806 can include optical drives like, compact disk ROM (CD-ROM), a CD recordable drive (CD-R drive), a CD rewriteable drive (CD-RW drive) and/or a digital versatile ROM drive (DVD ROM). The memory 1804 can store processes 1814 and/or data 1816, for example. The disk 1806 and/or memory 1804 can store an operating system that controls and allocates resources of the computer 1800.

The bus 1808 can be a single internal bus interconnect architecture and/or other bus architectures. The bus 1808 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and-a small computer systems interface (SCSI) bus.

The computer 1800 interacts with input/output devices 1818 via input/output ports 1810. Such input/output devices 1818 can include, but are not limited to, a keyboard, a microphone, a pointing and selection device, cameras, video cards, displays, and the like. The input/output ports 1810 can include but are not limited to, serial ports, parallel ports, and USB ports.

The computer 1800 can operate in a network environment and thus is connected to a network 1820 by a network interface 1812. Through the network 1820, the computer 1800 may be logically connected to a remote computer 1822. The network 1820 includes, but is not limited to, local area networks (LAN), wide area networks (WAN), and other networks. The network interface 1812 can connect to local area network technologies including, but not limited to, fiber distributed data interface (FDDI), copper distributed data interface (CDDI), ethernet/IEEE 802.3, token ring/IEEE 802.5, and the like. Similarly, the network interface 1812 can connect to wide area network technologies including, but not limited to, point to point links, and circuit switching networks like integrated services digital networks (ISDN), packet switching networks, and digital subscriber lines (DSL).

The systems, methods, and objects described herein may be stored, for example, on a computer readable media. Media can include, but are not limited to, an ASIC, a CD, a DVD, a RAM, a ROM, a PROM, a disk, a carrier wave, a memory stick, and the like.

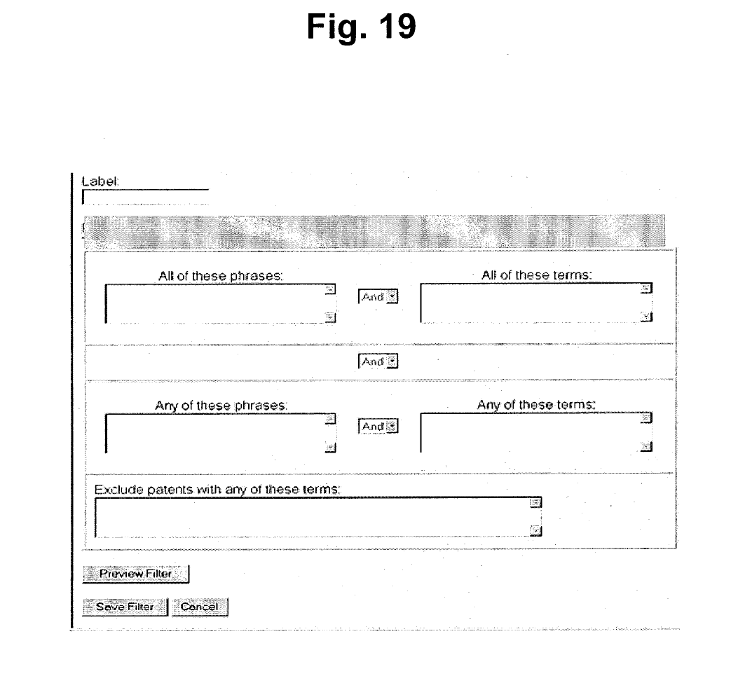

Turning now to FIG. 19, an example filter adding page on an example GUI is illustrated. The following table illustrates example choices a user can make in connection with the example page.

| | |
|---|---|
| Label | The user gives the filter a name |
| All these | The user lists a single phrase or multiple phrases separated by commas and a |
| phrases | parameter (i.e., w/30) indicating the number of characters by which the terms in |
| | the phrase may be separated |
| And / Or | This is a Boolean operator indicating that either the phrases and the terms in the |
| | next field or the phrases in the next field satisfy the definition. For example, |
| | radio frequency condition w/30 or RF. |
| All these | The user lists a single term or multiple terms separated by commas |
| terms | |
| And / Or | This is a further Boolean operator which indicates that the first criteria either and |
| | the next criteria or the next criteria satisfy the search |
| All these | This is a second set of criteria that may or may not be applied. If used, the user |
| phrases | lists a single phrase or multiple phrases separated by commas and a parameter |
| | (e.g., w/30) indicating the number of characters by which it may be separated |
| And / Or | This is a further Boolean operator indicating that either the phrases and the terms |
| | in the next field or the phrases in the next field satisfy the definition. |
| All these | The user lists a single term or multiple terms separated by commas |
| terms | |
| Exclude | The user lists a single term or multiple terms separated by commas. If system |
| patents with | identifies a patent meeting all other criteria, but includes any of these terms, that |
| any of these | patent will be excluded from the results. |
| terms | |
| Exclude | The user lists a single phrase or multiple phrases separated by commas. If |
| patents with | system identifies a patent meeting all other criteria, but includes any of these |
| any of these | phrases, that patent will be excluded from the results. |
| phrases | |
| Preview filter | The user can preview the filter. |
| Save / Cancel | The user can either save or cancel the filter as defined |

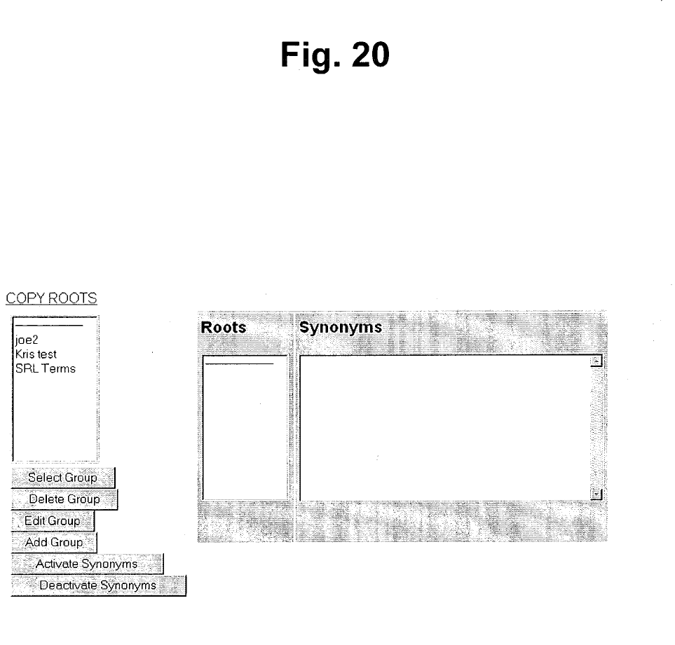

Turning now to FIG. 20, an example synonym editor page on an example GUI is illustrated. Through this example page, the user can take actions like:

Select an existing synonym group

Add a new synonym group

Edit an existing synonym group

Delete an existing synonym group

Set a synonym group as active synonyms for the current project

Deactivate synonyms for the current project

Copy Roots a process of copying root words between groups

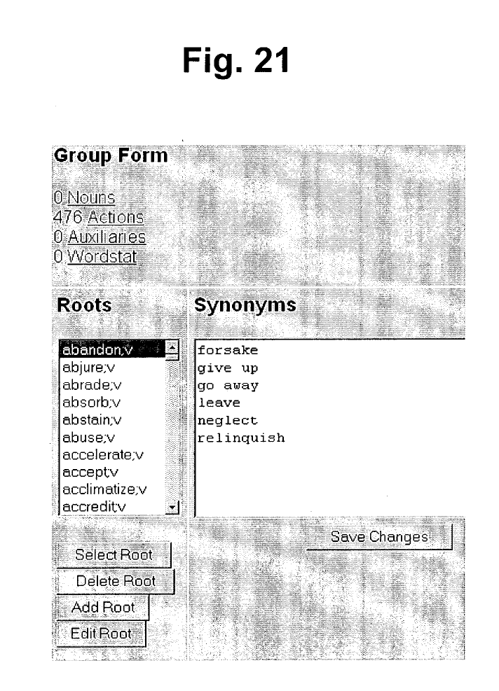

Turning now to FIG. 21, an example synonym grouping page on an example GUI is illustrated. Using this page, when the user has selected the synonym group the contents of the group are loaded. Words can have a number of synonyms associated with them. In the example, the root word abandon is identified as a verb (e.g., the “v” following the word) and synonyms are listed in the window on the right. The user can, for example:

Select a root word by clicking on it and then the Select Root button. When this is done the appropriate synonyms are loaded in the window labeled Synonyms.

Add a root word by clicking on the Add Root button and then filling out the form.

Edit the root word by clicking on it and then clicking on the Edit Root button and then filling out the form.

Delete a root word by clicking on it and then clicking on the Delete Root button. The user is then warned that the root word and its synonyms are about to be deleted from the database and confirmation for the deletion is required.

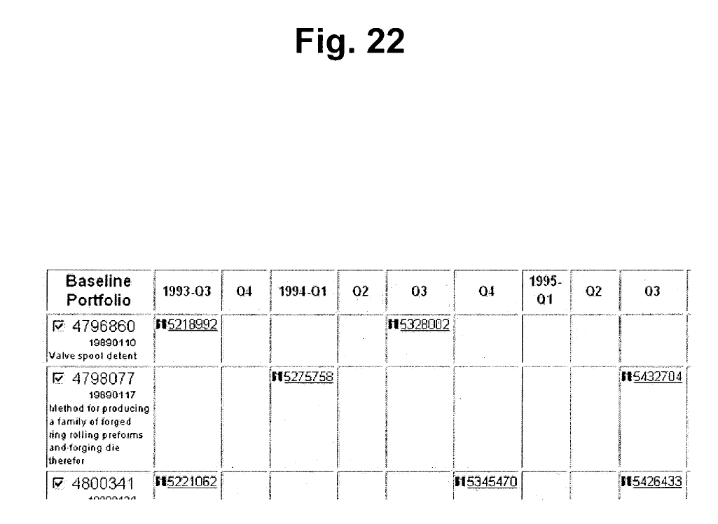

Turning now to FIG. 22, an example citation tree page on an example GUI is illustrated. Patents are listed in the column labeled Baseline Portfolio and are accompanied by a checkbox. The user can continue the expansion by clicking on additional patents in the Baseline Portfolio column. Based on the relationships between the patents in the citation tree, in one example the citing patent numbers can be highlighted with different colors. For example, green patent numbers may mean patents appear in the citation tree of multiple baseline patents, red patent numbers may mean self-citation, and purple patent numbers might belong to the Corporation. The data are presented, for example, by year and by quarter within each year. It is to be appreciated that other presentations can be made. By clicking on the hyperlinked patent numbers the user is taken to that patent. Hyperlinks within the patent take the user to the cited patents. It is to be appreciated that FIGS. 22 through 25 are merely examples and that additional, different, and/or fewer graphical user elements can be employed to produce other screens that provide similar, additional and/or alternative functionality.

While the systems, methods and so on herein have been illustrated by describing examples, and while the examples have been described in considerable detail, it is not the intention of the applicants to restrict or in any way limit the scope of the appended claims to such detail. Additional advantages and modifications will be readily apparent to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

What has been described above includes several examples. It is, of course, not possible to describe every conceivable combination of components or methodologies for purposes of describing the systems, methods, computer readable media and so on employed in patent data mining. However, one of ordinary skill in the art may recognize that further combinations and permutations are possible. Accordingly, this application is intended to embrace alterations, modifications, and variations that fall within the scope of the appended claims. The scope of the invention is to be determined only by the appended claims and their equivalents.

Furthermore, to the extent that the term “includes” is employed in the detailed description or the claims, it is intended to be inclusive in a manner similar to the term “comprising” as that term is interpreted when employed as a transitional word in a claim. Further still, to the extent that the term “or” is employed in the claims (e.g., A or B) it is intended to mean “A or B or both”. When the author intends to indicate “only A or B but not both”, then the author will employ the term “A or B but not both”. Thus, use of the term “or” herein is the inclusive, and not the exclusive, use. See BRYAN A. GARNER, A DICTIONARY OF MODERN LEGAL USAGE 624 (2d Ed. 1995).

What is claimed is:

1. A computer implemented data mining method, comprising:
programmatically generating a series of cross tabulated searches;
electronically retrieving one or more documents from a document database based on the series of cross tabulated searches;
removing irrelevant documents from the retrieved documents; and
producing a matrix of retrieved relevant documents that facilitate visualizing one or more relationships between the retrieved relevant documents and a business problem.

2. The method of claim 1, comprising:
parsing the one or more relevant documents into parsed units suitable for input to subsequent automated processors.

3. The method of claim 2, where the parsed units are one or more of a word, a phrase, a sentence, and a paragraph.

4. The method of claim 1, where the documents are patents.

5. The method of claim 1, comprising:
producing a multi-dimensioned spreadsheet like graph that displays a high level relationship between patents.

6. The method of claim 1, comprising:
producing a multi-dimensioned spreadsheet like graph that displays a high level relationship between companies based on patents related to the companies.

7. The method of claim 1, comprising:
producing a multi-dimensioned spreadsheet like graph that displays a high level relationship between technologies based on patents concerning the technologies.

8. The method of claim 1, comprising:
producing a donation assessment list comprising one or more patents in the matrix.

9. The method of claim 1, comprising:
producing a solicitation package concerning one or more patents in the matrix.

10. A computer readable medium storing computer executable instructions for the method of claim 1.

11. A computerized data mining system, comprising:
a query generator that generates a set of cross tabulated queries for retrieving a cross-referenceable set of documents;
a search engine that searches a document database using the set of queries and returns one or more documents; and
a graphical user interface for displaying a matrix or a multi-dimensional spreadsheet like graph.

12. The system of claim 11, where the document database is a patent database that patent data from the United States Patent and Trademark Office that has been reformatted into an SQL searchable database.

13. The system of claim 11, where the multi-dimensional spreadsheet like graph is a bubble plot that displays relationships between high level patent data.

14. A computer readable medium storing computer executable instructions for the method of claim 11.

15. A computer implemented data mining System, comprising:
a pattern matcher computer component in data communication with a document database, the pattern matcher programmed to extract one or more documents from the document database;
a technical attribute identifier computer component that identifies the presence of one or more technical attributes in an extracted document;
a data analyzer computer component that generates a matrix of information that relates two or more extracted documents based, at least in part, on a technical attribute; and
a logic for producing a spreadsheet like graph bubble plot.

16. The system of claim 15 where the document database is a patent database.

17. A computer component based data mining method, comprising:
searching one or more data stores that are searchable on relationships between documents and one or more of a technology landscape and a company landscape;
outputting a matrix of cross-referenced documents related to one or more of the technology landscape and the company landscape retrieved from the searchable database; and
outputting a spreadsheet like graph bubble plot that illustrates a multi-dimensional relationship between high level patent data associated with the matrix of cross-referenced documents.

18. The method of claim 17, comprising:
in response to a cell in the matrix being selected, displaying data upon which the matrix was constructed.

19. The method of claim 17, comprising:
extracting data from the matrix, where the data is the data upon which the matrix was constructed; and
storing the data in a data store in a format suitable for subsequent automated processing.

20. The method of claim 19, where the subsequent automated processing comprises one or more of, data analysis for search term expansion, and spread sheeting for graphing.

21. A data mining method, comprising:
defining one or more application areas to be mined;
defining one or more product forms for a product associated with a defined application area;
defining one or more technology forms for a technology associated with the defined application area or the defined product form;
generating a set of cross tabulated queries comprised of one or more search terms based on the defined application areas, the defined product forms, or the defined technology forms;
searching one or more documents in a document database using the set of cross-tabulated queries;
determining whether the one or more search terms are sufficient to limit the documents acquired from the document database to relevant documents;
selectively updating one or more search terms based on determining the sufficiency of the search terms;
resubmitting the query to a search engine;
re-initiating a search in the document database using the resubmitted query; and
receiving one or more documents responsive to the search.

22. The method of claim 21, where the subsequent automated processing is one or more of data analysis for search term expansion, and spread sheeting for graphing.

23. A patent data mining method, comprising:
accessing one or more matrices that store cross tabulated data from one or more of an attribute landscape generation and a technology landscape generation;
identifying one or more patents that are candidates for donation based on data stored in the one or more matrices; and
presenting the candidate patents.

24. A patent data mining method, comprising:
accessing one or more matrices that store cross tabulated data from one or more of an attribute landscape generation and a technology landscape generation;
identifying one or more key patents based on data stored in the one or more matrices; and
presenting a spreadsheet like graphical display of the key patents.

25. The method of claim 24, comprising:
identifying one or more potential licensees, assignees, or purchasers of the one or more key patents based on data stored in the one or more matrices; and
presenting a spreadsheet like graphical display of one or more relationships between the key patents and the potential licensees, assignees, or purchasers.

26. In a computer system having a graphical user interface comprising a display and a selection device, a method of providing and selecting from a set of data entries on the display, the method comprising:
retrieving a set of data entries, each of the data entries representing one of a choice for patent data mining;
displaying the set of entries on the display;
receiving a data entry selection signal indicative of the selection device selecting a selected data entry; and
in response to the data entry selection signal, initiating an operation associated with the selected data entry.
